(19) United States
(12) Patent Application Publication
(10) Pub. No.: US 2025/0266476 A1
(43) Pub. Date: Aug. 21, 2025

(54) CONDENSER-BASED ANODE HYDROGEN PRECONDITIONING

(71) Applicant: ZeroAvia Ltd, Cirencester (GB)

(72) Inventors: James Holt, Cirencester (GB); Matt Legg, Cirencester (GB)

(21) Appl. No.: 19/058,979

(22) Filed: Feb. 20, 2025

(30) Foreign Application Priority Data
Feb. 21, 2024 (GB) 2402476.2

(51) Int. Cl. H01M 8/04082; H01M 8/04007; H01M 8/04119; H01M 8/04701; H01M 8/04828

(52) U.S. Cl. CPC H01M 8/04201; H01M 8/04074; H01M 8/04164; H01M 8/04716; H01M 8/04843

(57) ABSTRACT

Disclosed is a hydrogen feed conditioning system for a hydrogen fuel cell in which fresh hydrogen from storage and recycled hydrogen from an anode exhaust of the fuel cell are mixed and fed to an anode feed of the fuel cell. A stream of recycled hydrogen is first passed through a hydrogen/water separator configured to reduce an amount of water vapor in the recycled hydrogen stream. The system includes a condenser for the anode exhaust stream upstream of the hydrogen water separator.

### CROSS REFERENCE TO RELATED APPLICATION

This application claims benefit to UK Application Serial No. 2402476.2, filed Feb. 21, 2024, the contents of which are incorporated herein by reference.

### TECHNICAL FIELD

The present disclosure relates to fuel cell systems and methods for operating same. The disclosure has particular utility in connection with the preconditioning of hydrogen fuel feeds for low temperature proton exchange membrane (LT-PEM) hydrogen (H₂) fuel cells for use in H₂ fuel-cell-powered vehicles, including aircraft, and will be described in connection with such utility, although other utilities are contemplated.

### BACKGROUND AND SUMMARY

This section provides background information which is not necessarily prior art, and is related to the present disclosure. This section provides a general summary of the disclosure and is not a comprehensive disclosure of its full scope or all its features.

In operation, an H₂ fuel cell requires that the H₂ supplied to the anode of the fuel cell be within defined temperature, humidity, and pressure ranges to ensure efficient operation of the fuel cell. This requires pre-conditioning of the H₂ prior to feeding it to the anode.

In practice, the H₂ supplied to an H₂ fuel cell is a combination of two streams mixed via a venturi tube [operating by the Venturi effect]:
1. A fresh H₂ stream from an H₂ fuel tank of the H₂ management system (HMS). This H₂ stream typically is quite cold and has a relative humidity (RH) of 0%; and
2. An H₂ and water vapor stream that has been recirculated from the anode exhaust. This stream is warm and typically has a RH of 100%.

A common practice of the prior art is to heat up fresh, relatively cold and dry H₂ from the H₂ fuel tank, (typically −40° C. and 0% relative humidity) prior to mixing it with relatively warm and moist recirculated H₂ from the anode exhaust (typically +80° C. and 100% relative humidity). The purpose of this heat exchange (HEX) is to add sufficient heat and humidity to the fresh H₂ so that, when the fresh H₂ stream and the H₂ recycled stream are mixed, the mixed stream has the desired relative humidity of 30-60% and temperature gradient (from −40° C. to +80° C.). FIG. 1 plots relative humidity at the anode inlet as a function of H₂ temperature supplied from the H₂ tank of a typical prior art HMS. As shown in FIG. 1, the minimum temperature of the supplied H₂ from the HMS needs to be approximately 45° C. to achieve a relative humidity in the 30-60% range.

In practice, H₂ fuel cells use coolant-hydrogen heat exchangers (HEXs) with relatively high heat transfer areas in order to achieve the desired relative humidity and temperature of anode fuel when mixing together fresh H₂ and recirculated H₂. These HEXs add cost, complexity, and weight to the coolant system and may result in an additional failure mode in which H₂ may leak into the coolant system and be transported through the coolant pipework to undesirable parts of the powertrain installation where the H₂ could ignite or explode.

FIG. 2 illustrates a prior art anode hydrogen preconditioning system 8. In practice, H₂ recycle anode exhaust stream 10 from a fuel cell (not shown) is passed via a conduit 12 to an H₂/water separator 14 in which liquid water is separated and passed via line 16 to exhaust or used to add humidity to cabin air in accordance with the teachings of co-pending U.S. application Ser. No. 18/338,205, filed Jun. 20, 2023, the contents of which are incorporated by reference. And fresh H₂ from an H₂ fuel tank 18 is passed via conduit 20 through a heat exchanger (HEX) 22, where the H₂ is warmed to a desired operating temperature by heat exchange with coolant circulated through the fuel cell (not shown) via conduit 24. Due to the high heat loads that need to be transferred from the fuel cell particularly in certain stages of flight, i.e., take-off and climb, HEX 22 is a dedicated high heat transfer area coolant-H₂ HEX. The H₂/water separator 14 removes liquid water from the anode exhaust prior to recirculating the H₂ as feed to the anode. The warmed fresh H₂ exiting HEX 22 via conduit 26 is mixed in venturi tube 28 with recycled H₂ exiting H₂/water separator 14 via conduit 27, and the mixture is then introduced into the fuel cell via anode inlet line 30.

The requirement of a dedicated high heat transfer area coolant-H₂ HEX 22 adds cost, complexity, and weight to the coolant system and results in an additional failure mode in which H₂ may leak into the coolant system and be transported through the coolant pipework to undesirable parts of the powertrain installation where the H₂ could be ignited or explode. This failure mode is a consequence of the HEX requiring a high heat transfer area.

In accordance with the present disclosure, we add a condenser in the anode exhaust line, upstream of the H₂/water separator.

More particularly, in accordance with Aspect A we provide an H₂ feed conditioning system for an H₂ fuel cell in which fresh hydrogen from storage and recycled H₂ from an anode exhaust of the fuel cell are mixed and fed to an anode feed of the fuel cell, wherein a stream comprising the recycled H₂ is first passed through an H₂/water separator configured to reduce an amount of water vapor in the recycled H₂ stream, and wherein the system includes a condenser for the anode exhaust stream upstream of the H₂ water separator.

In one embodiment, the anode exhaust stream is cooled by HEX with the fresh H₂ in the condenser.

In another embodiment fresh H₂ gas after passing through the condenser and recycled H₂ after passing through the H₂ water separator are mixed prior to being fed to the fuel cell anode.

In yet another embodiment the fresh H₂ gas and recycled H₂ are mixed in a venturi tube.

In yet another embodiment the fresh H₂ after passing through the condenser is passed directly to the venturi tube.

In a further embodiment fresh H₂ after passing through the condenser is passed through a fuel cell HEX prior to passing to the venturi tube.

In yet another embodiment the mixture of fresh H₂ and recycled H₂ has a relative humidity of 30-60%.

In still another embodiment the mixture of fresh H₂ and recycled H₂ stream has a temperature of −40° C. to +80° C.

In a further embodiment the fuel cell HEX comprises an elongated chamber having a cooling tube configured to carry the recycled H₂ through an interior of the elongated chamber for HEX with the fresh H₂.

According to Aspect B there is provided a method for conditioning H₂ for feeding an H₂ fuel cell, wherein fresh H₂ from storage and recycled H₂ from an anode exhaust from the fuel cell are mixed and fed to an anode feed of the fuel cell, and wherein the recycled H₂ is first passed through an H₂/water separator configured to reduce an amount of water vapor in the recycled H₂ stream, said method comprising the steps of passing the recycled H₂ stream through a condenser upstream of the H₂ water separator before passing the recycled H₂ stream to the H₂/water separator.

In one embodiment of the method the anode exhaust stream is cooled by HEX with the fresh H₂ in the condenser.

In another embodiment of the method fresh H₂ gas after passing through the condenser and recycled H₂ after passing through the H₂ water separator are mixed prior to being fed to the fuel cell anode.

In still another embodiment of the method the fresh H₂ and recycled H₂ are mixed in a venturi tube.

In still another embodiment of the method the fresh H₂ after passing through the condenser is passed directly to the venturi tube.

In a further embodiment of the method fresh H₂ after passing through the condenser is passed through a fuel cell HEX prior to passing to the venturi tube.

In yet another embodiment of the method the mixture of fresh H₂ and recycled H₂ has a relative humidity of 30-60%.

In still another embodiment of the method the mixture of fresh H₂ and recycled H₂ stream has a temperature of −40° C. to +80° C.

In a further embodiment of the method the fuel cell HEX comprises an elongated chamber having cooling tubes configured to carry the recycled H₂ through an interior of the elongated chamber for HEX with the fresh H₂.

According to Aspect C, the anode feed conditioning system of Aspect A is installed on a vehicle.

According to another embodiment of Aspect C, the vehicle is an aircraft.

According to Aspect D of the present invention there is provided a hydrogen feed conditioning system for a hydrogen fuel cell in which fresh hydrogen from storage and recycled hydrogen from an anode exhaust of the fuel cell are mixed and fed to an anode feed of the fuel cell, wherein a stream comprising the recycled hydrogen is first passed through a hydrogen/water separator configured to reduce an amount of water vapor in the recycled hydrogen stream, and wherein the system includes a condenser for the anode exhaust stream, performed by or upstream of the hydrogen water separator.

Preferably the anode exhaust stream is cooled by heat exchange with the fresh hydrogen in the condenser.

Preferably fresh hydrogen gas after passing through the condenser and recycled hydrogen after passing through the hydrogen water separator are mixed prior to being fed to the fuel cell anode.

Preferably the fresh hydrogen gas and recycled hydrogen are mixed in a venturi tube.

In one alternative the fresh hydrogen after passing through the condenser is passed directly to the venturi tube.

In another alternative the fresh hydrogen after passing through the condenser is passed through a fuel cell heat exchanger prior to passing to the venturi tube.

Preferably the mixture of fresh hydrogen and recycled hydrogen has a relative humidity of 30-60%.

8 Preferably the mixture of fresh hydrogen and recycled hydrogen stream has a temperature of −40° C. to +80° C.

Preferably the fuel cell heat exchanger comprises an elongated chamber having a cooling tube configured to carry the recycled hydrogen through an interior of the elongated chamber for heat exchange with the fresh hydrogen.

According to Aspect E of the present invention there is provided a method for conditioning hydrogen for feeding a hydrogen fuel cell using the hydrogen feed conditioning system according to Aspect D of the present invention wherein fresh hydrogen from storage and recycled hydrogen from an anode exhaust from the fuel cell are mixed and fed to an anode feed of the fuel cell, and wherein the recycled hydrogen is first passed through a hydrogen/water separator configured to reduce an amount of water vapor in the recycled hydrogen stream, said method comprising the steps of passing the recycled hydrogen stream through a condenser upstream of the hydrogen water separator before passing the recycled hydrogen stream to the hydrogen/water separator.

Preferably the anode exhaust stream is cooled by heat exchange with the fresh hydrogen in the condenser.

Preferably fresh hydrogen gas after passing through the condenser and recycled hydrogen after passing through the hydrogen water separator are mixed prior to being fed to the fuel cell anode.

Preferably the fresh hydrogen and recycled hydrogen are mixed in a venturi tube.

In one alternative the fresh hydrogen after passing through the condenser is passed directly to the venturi tube.

In another alternative the fresh hydrogen after passing through the condenser is passed through a fuel cell heat exchanger prior to passing to the venturi tube.

Preferably the mixture of fresh hydrogen and recycled hydrogen has a relative humidity of 30-60%.

Preferably the mixture of fresh hydrogen and recycled hydrogen stream has a temperature of −40° C. to +80° C.

Preferably the fuel cell heat exchanger comprises an elongate chamber having cooling tubes configured to carry the recycled hydrogen through an interior of the elongate chamber for heat exchange with the fresh hydrogen.

According to Aspect F of the present invention there is provided a method for conditioning hydrogen for feeding a hydrogen fuel cell, wherein fresh hydrogen from storage and recycled hydrogen from an anode exhaust from the fuel cell are mixed and fed to an anode feed of the fuel cell, and wherein the recycled hydrogen is first passed through a hydrogen/water separator configured to reduce an amount of water vapor in the recycled hydrogen stream, said method comprising the steps of passing the recycled hydrogen stream through a condenser upstream of the hydrogen water separator before passing the recycled hydrogen stream to the hydrogen/water separator.

Preferably the anode exhaust stream is cooled by heat exchange with the fresh hydrogen in the condenser.

Preferably fresh hydrogen gas after passing through the condenser and recycled hydrogen after passing through the hydrogen water separator are mixed prior to being fed to the fuel cell anode.

Preferably the fresh hydrogen and recycled hydrogen are mixed in a venturi tube.

In one alternative the fresh hydrogen after passing through the condenser is passed directly to the venturi tube.

In another alternative the fresh hydrogen after passing through the condenser is passed through a fuel cell heat exchanger prior to passing to the venturi tube.

Preferably the mixture of fresh hydrogen and recycled hydrogen has a relative humidity of 30-60%.

Preferably the mixture of fresh hydrogen and recycled hydrogen stream has a temperature of −40° C. to +80° C.

Preferably the fuel cell heat exchanger comprises an elongate chamber having cooling tubes configured to carry the recycled hydrogen through an interior of the elongate chamber for heat exchange with the fresh hydrogen.

According to Aspect G of the present invention there is provided a hydrogen feed conditioning system according to Aspect D of the present invention, installed on a vehicle. Preferably the vehicle is an aircraft.

Adding a condenser in the anode exhaust line upstream of the H₂/water separate provides several functions and advantages. For one, we reduce the amount of water vapor (and thus relative humidity) that is in the mixed flow when the H₂ exhaust is recirculated and mixed with fresh H₂ from the fuel tank and supplied to the anode inlet.

Secondly, the need for a high heat transfer surface area coolant-H₂ HEX is reduced. Instead, a small heat transfer area coolant-H₂ HEX may be used, or potentially no coolant-H₂ HEX is needed at all. This reduces the amount of water vapor present in the anode inlet and therefore reduces the required additional heat for achieving sufficiently low relative humidity. Also, providing a condenser in the anode exhaust line upstream of the H₂ water separator in accordance with the present disclosure, eliminates/or at least significantly reduces a potential of H₂ leaking into the coolant system and being transported through the coolant pipework to undesirable parts of the powertrain where the hydrogen could be ignited or explode. Additionally providing a condenser in the anode exhaust line upstream of the water separator in accordance with the present disclosure, reduces complexity, cost, and weight of the coolant system.

No known anode preconditioning system employs a condenser in the anode exhaust, upstream of the H₂/water separator, instead of the commonly used high heat transfer surface area coolant-H₂ HEX to provide heat addition to the fresh H₂ and ensure the anode inlet H₂ stream is sufficiently warm and has a target relative humidity for optimized fuel cell performance.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a graph plotting percent relative humidity at a fuel cell anode inlet vs. temperature of H₂ flowing in from the HMS in accordance with the prior art;

FIG. 2 is a schematic flow diagram of an anode H₂ preconditioning system in accordance with the prior art;

FIG. 3 is a schematic diagram of an anode H₂ preconditioning system in accordance with a first embodiment of the present disclosure;

FIG. 4A is a side elevational view of a simplified HEX for an anode H₂ preconditioning system with a condenser in accordance with the present disclosure;

FIG. 4B is a side cross-sectional view of the simplified HEX of FIG. 4A;

FIG. 5 is a schematic view of an anode H₂ preconditioning system in accordance with a second embodiment of the present disclosure;

FIG. 6 is a graph plotting precent relative humidity at the anode inlet vs. temperature at the H₂ flowing in from an HMS in accordance with the present disclosure; and

FIG. 7 is a schematic depiction of an aircraft incorporating an anode H₂ preconditioning of FIG. 3.

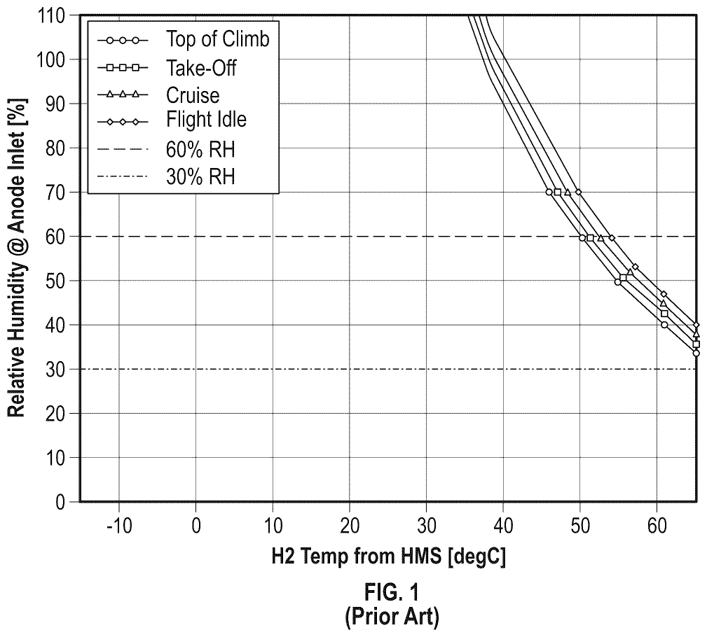

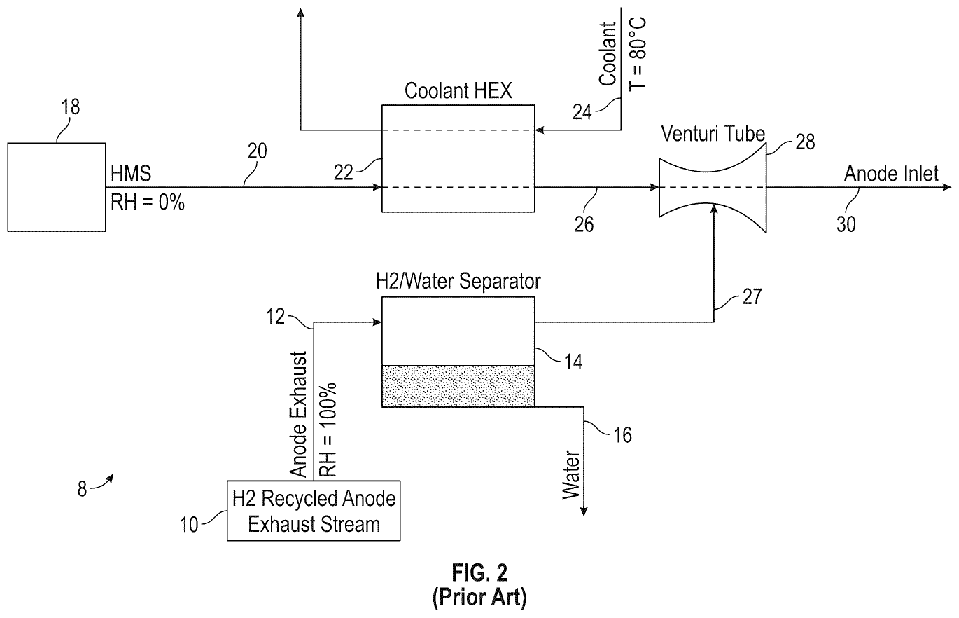

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

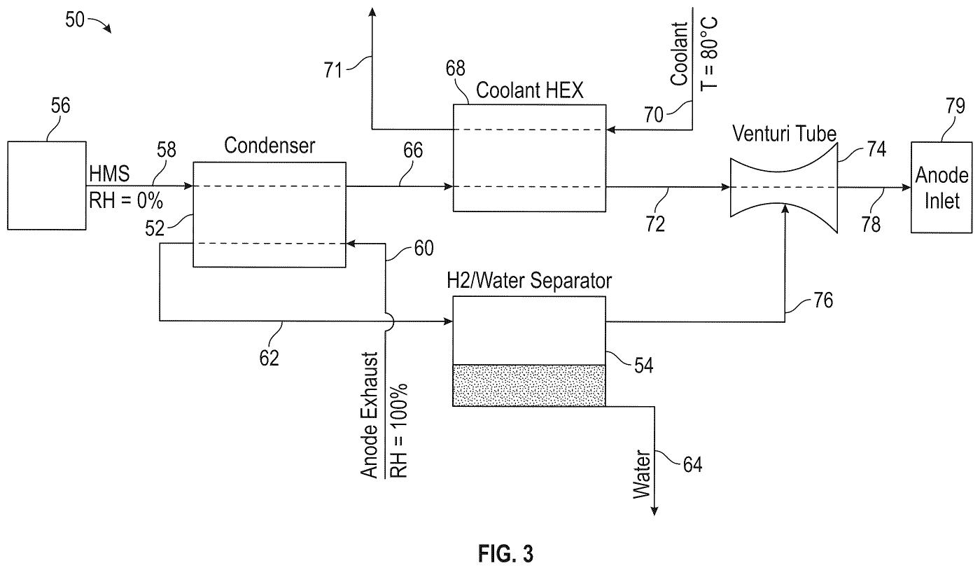

FIG. 3 illustrates a feed conditioning system for a hydrogen fuel cell in accordance with the present disclosure. The hydrogen feed conditioning system 50 comprises a condenser 52 upstream of an H₂/water separator 54. In other embodiments, the condensing and water separation functions may be carried out by the condenser 52 alone (i.e., separately drawn H₂/water separator 54 is optional). Fresh H₂ is fed from an H₂ fuel tank 56 via conduit 58 in heat exchange with warm moist recycled H₂ from the anode exhaust delivered by conduit 60.

The warm recycled H₂ is cooled by contact with the cold fresh H₂, and the cooled recycled H₂ is passed via conduit 62 to water separator 54 where liquid water is separated and passed as exhaust by conduit 64. Alternatively, a portion of the condensed water may be used to add humidity to cabin air in accordance with the teaching of our co-pending U.S. application Ser. No. 18/338,205, filed Jun. 20, 2023, the contents of which are incorporated herein by reference.

The fresh H₂ from condenser 52 is then passed via conduit 66 to simplified coolant heat exchanger (HEX) 68 where the fresh H₂ is further warmed by heat exchange with coolant delivered via conduit 70 from the fuel cell (not shown). The coolant is then returned to the fuel cell via conduit 71.

Warm fresh H₂ is then passed from coolant HEX 68 via conduit 72 where it is mixed in venturi tube 74 with warm moist recycled H₂ delivered from water separator 54 by conduit 76. The mixture of fresh H₂ and recycled H₂ stream, which has a temperature of −40° C. to +80° C. and relative humidity of 30-60%, is then passed as feed to the anode inlet 79 via conduit 78.

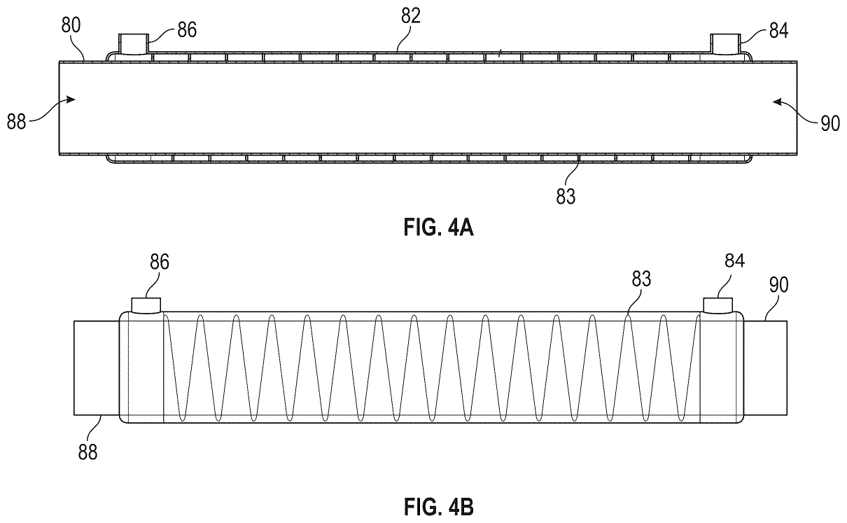

Referring to FIGS. 4A and 4B, simplified coolant HEX 68 preferably comprises an elongated vessel with an internal pipe 80 coaxially supported within an external pipe 82. External pipe 82 is sealed at its ends, and has an external pipe inlet 84 adjacent one end and an external pipe outlet 86 adjacent the other end.

A helically shaped heat exchanger coil 83 is located within internal pipe 80 and is connected at one end to external pipe inlet 84 and at its other end to external pipe outlet 86. Internal pipe 80 has an inlet 88 at one end and outlet 90 at the other end.

In operation, recycled H₂ enters external pipe inlet 84 and exits external pipe outlet 86, passing in heat exchanger coil 83 with fresh H₂ which enters inlet end 88 of internal pipe 80 and exits internal outlet pipe 90.

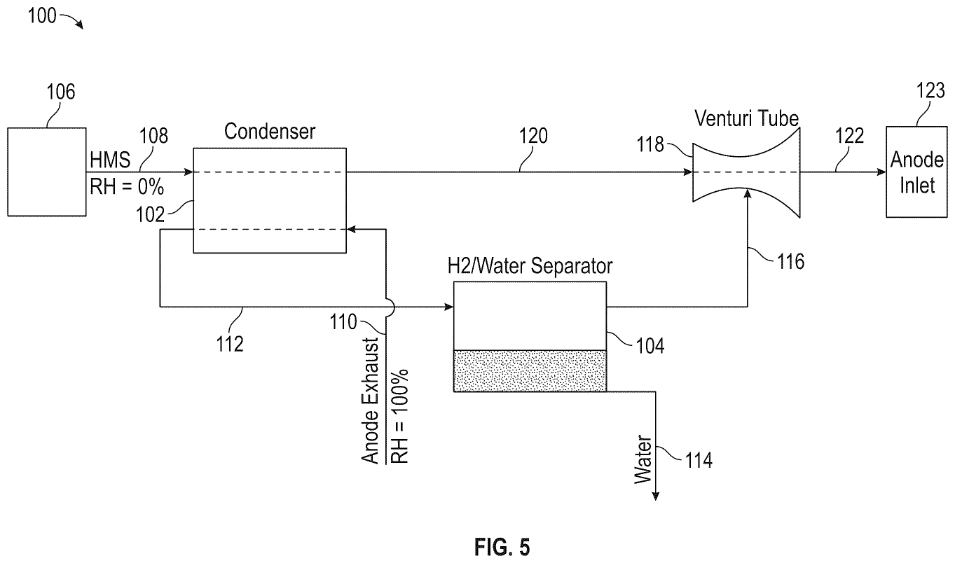

Depending on performance of the condenser it is possible to eliminate the need for a separate H₂ HEX entirely. According to FIG. 5, there is provided a high efficiency anode H₂ preconditioning system 100. Anode H₂ preconditioning system 100 includes a condenser 102 and an H₂/water separator 104, i.e., similar to the system of FIG. 3. However, in the FIG. 5 embodiment, the coolant H₂ HEX is eliminated entirely. Thus, in the FIG. 5 embodiment, fresh H₂ from the fuel tank 106 is passed via conduit 108 to condenser 102 where the cold dry H₂ is passed in heat exchanger with warm moist recycled H₂ introduced into condenser 102 via line 110. The cold (fresh) H₂ is thus warmed to a desired operating temperature by heat exchanger with the warm recycled H₂ while within the condenser 102. Condenser 102 also includes an outlet for passing cooled recycled H₂ via conduit 112 to water separator 104 where liquid water is separated as before and passed to exhaust via conduit 114. The cool recycled H₂ is passed via conduit 116 to venturi tube 118 where it is mixed with warm fresh H₂ delivered from condenser 102 via conduit 120 to venturi tube 118, and the mixture is then supplied as feed to the fuel cell anode inlet 123 via conduit 122.

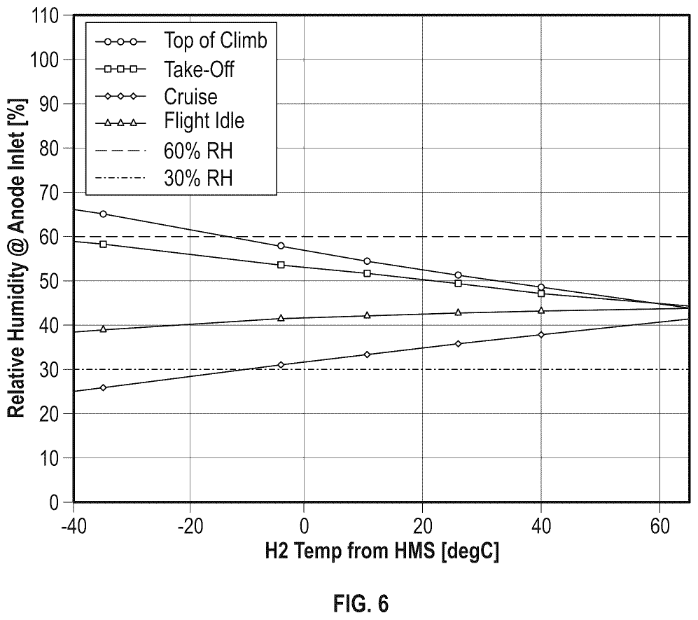

FIG. 6 plots relative humidity at the anode inlet as a function of H₂ temperature supplied from the H₂ tank in a fuel cell aviation system employing an H₂ preconditioning system of FIG. 5. As can be seen, relative humidity at the anode inlet verses temperature of the H₂ feed from the HMS depends on the stage of flight (i.e. take-off, top of climb, cruise, flight idle) and is significantly more controlled and maintained within a narrow range with the present disclosure.

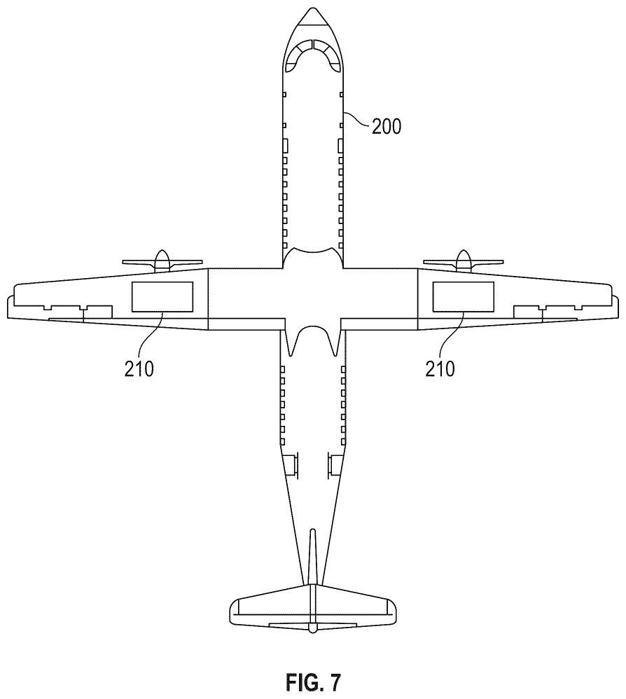

FIG. 7 illustrates an aircraft 200 including an integrated fuel-cell-electric system 210 including an H₂ preconditioning system in accordance with the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A hydrogen feed conditioning system for a hydrogen fuel cell in which fresh hydrogen from storage and recycled hydrogen from an anode exhaust of the fuel cell are mixed and fed to an anode feed of the fuel cell, wherein a stream comprising the recycled hydrogen is first passed through a hydrogen/water separator configured to reduce an amount of water vapor in the recycled hydrogen stream, and wherein the system includes a condenser for the anode exhaust stream, performed by or upstream of the hydrogen water separator.

2. The system of claim 1, wherein the anode exhaust stream is cooled by heat exchange with the fresh hydrogen in the condenser.

3. The system of claim 1, wherein fresh hydrogen gas after passing through the condenser and recycled hydrogen after passing through the hydrogen water separator are mixed prior to being fed to the fuel cell anode.

4. The system of claim 3, wherein the fresh hydrogen gas and recycled hydrogen are mixed in a venturi tube.

5. The system of claim 4, wherein the fresh hydrogen after passing through the condenser is passed directly to the venturi tube.

6. The system of claim 4, wherein the fresh hydrogen after passing through the condenser is passed through a fuel cell heat exchanger prior to passing to the venturi tube.

7. The system of claim 3, wherein the mixture of fresh hydrogen and recycled hydrogen has a relative humidity of 30-60%.

8. The system of claim 3, wherein the mixture of fresh hydrogen and recycled hydrogen stream has a temperature of −40° C. to +80° C.

9. The system of claim 6, wherein the fuel cell heat exchanger comprises an elongated chamber having a cooling tube configured to carry the recycled hydrogen through an interior of the elongated chamber for heat exchange with the fresh hydrogen.

10. A method for conditioning hydrogen for feeding a hydrogen fuel cell using the hydrogen feed conditioning system of claim 1 wherein fresh hydrogen from storage and recycled hydrogen from an anode exhaust from the fuel cell are mixed and fed to an anode feed of the fuel cell, and wherein the recycled hydrogen is first passed through a hydrogen/water separator configured to reduce an amount of water vapor in the recycled hydrogen stream, said method comprising the steps of passing the recycled hydrogen stream through a condenser upstream of the hydrogen water separator before passing the recycled hydrogen stream to the hydrogen/water separator.

11. A method for conditioning hydrogen for feeding a hydrogen fuel cell, wherein fresh hydrogen from storage and recycled hydrogen from an anode exhaust from the fuel cell are mixed and fed to an anode feed of the fuel cell, and wherein the recycled hydrogen is first passed through a hydrogen/water separator configured to reduce an amount of water vapor in the recycled hydrogen stream, said method comprising the steps of passing the recycled hydrogen stream through a condenser upstream of the hydrogen water separator before passing the recycled hydrogen stream to the hydrogen/water separator.

12. The method of claim 11, wherein the anode exhaust stream is cooled by heat exchange with the fresh hydrogen in the condenser.

13. The method of claim 11, wherein the fresh hydrogen gas after passing through the condenser and recycled hydrogen after passing through the hydrogen water separator are mixed prior to being fed to the fuel cell anode.

14. The method of claim 13, wherein the fresh hydrogen and recycled hydrogen are mixed in a venturi tube.

15. The method of claim 14, wherein the fresh hydrogen after passing through the condenser is passed directly to the venturi tube.

16. The method of claim 14, wherein the fresh hydrogen after passing through the condenser is passed through a fuel cell heat exchanger prior to passing to the venturi tube.

17. The method of claim 11, wherein the mixture of fresh hydrogen and recycled hydrogen has a relative humidity of 30-60%, and/or a temperature of −40° C. to +80° C.

18. The method of claim 16, wherein the fuel cell heat exchanger comprises an elongate chamber having cooling tubes configured to carry the recycled hydrogen through an interior of the elongate chamber for heat exchange with the fresh hydrogen.

19. The hydrogen feed conditioning system of claim 1, installed on a vehicle, preferably an aircraft.
